(19) United States
(12) Patent Application Publication
(10) Pub. No.: US 2004/0162660 A1
(43) Pub. Date: Aug. 19, 2004

(54) Reduction of the thermal stress of starting switch elements in automatic gearboxes or in automated manual gearboxes

(76) Inventors: Georg Gierer, Kressbronn (DE); Josef Haupt, Tettnang (DE); Christian Popp, Kressbronn (DE); Klaus Steinhauser, Kressbronn (DE); Peter Schiele, Kressbronn (DE)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/479,662

(22) PCT Filed: Jun. 19, 2002
(86) PCT No.: PCT/EP02/06757

(30) Foreign Application Priority Data
Jun. 23, 2001 (DE) 101 30 390.4

(51) Int. Cl. G06F 19/00

(52) U.S. Cl. 701/55; 701/90

(57) ABSTRACT

Within the framework of a method for reducing the thermal stress of starting shift elements in automatic gearboxes or automated manual gearboxes with at least two shift elements in the force flow, on starting, besides a first shift element at least a further shift element is used to take up at least part of the slippage.

The present invention concerns a method for reducing the thermal stress of starting shift elements in automatic gearboxes or automated manual gearboxes for a motor vehicle, according to the preamble of claim 1.

In automatic gearboxes or automated manual gearboxes with a wet or dry starting clutch, the problem arises that if the starting clutch is thermally overloaded because of slip operation, the clutch may be damaged or destroyed.

In such a situation, the clutch remains open such that no force flow can get through to the drive axle, so that the vehicle remains at rest and can no longer be moved. Further driving is only possible once the clutch has cooled down again.

Moreover, if the shift element has been damaged by overload, in most cases further driving is no longer possible at all.

Usually, starting shift elements are designed for maximum starting torque. For example, there are automatic gearboxes with an integrated wet forward gear clutch and an integrated wet reversing gear brake. In these known gearboxes, the forward gear clutch and the reversing gear brake must be designed in relation to thermal stress resistance such that they can each tolerate 100% of the starting slippage, and this results in large, heavy and expensive clutches as well as reduced driver comfort, for example, when starting in the low-load range, since the starting clutch is not designed to be “sensitive” enough to ensure comfortable starting. In the case of clutches with smaller dimensions, a reduction of the engine torque is necessarily entailed, but this too can be perceived by the driver as inconvenient.

From EP 0 890 945 B1 by the present inventor, a method is known for controlling a reversing transmission in working machinery, to reduce the high thermal stress in shift elements when reversing. The scope of that patent includes taking up part of the slippage by an additional clutch.

The purpose of the present invention is to indicate a method for reducing the thermal stress in starting shift elements of automatic gearboxes or automated manual gearboxes which avoids thermal overload of the shift elements as much as possible while using shift elements available in any case. When the overload limit of a starting clutch is reached, further driving is made possible and immobilization of the vehicle is avoided.

Furthermore, starting in the lower range is designed to be as comfortable as possible.

A further aim of the method is to provide the driver with sufficient starting acceleration when starting under full load.

It is proposed to use several shift elements when starting. This requires no additional shift elements, since in automatic gearboxes of the newer generation two or more clutches and/or brakes are involved in the force flow when in any gear.

In the context of the invention, it is provided that when it has been established that a shift element is at its thermal stress limit, this shift element is no longer used during starting (slip operation) until it has sufficiently cooled down.

To enable starting to continue, this task is taken up by the other shift element in the force flow. If more than two shift elements are involved in the force flow, this replacement strategy can be extended to the other shift elements as well.

The prerequisite for this is a monitoring function, which checks the thermal stress in the shift elements via a heat model or a direct heat measurement at the shift elements.

In a variant of the method according to the invention, it is proposed to shift to another gear when a shift element has reached its thermal stress limit, so as to use the shift elements in the force flow in the other gear as slipping starting elements.

If overload occurs during the starting process, i.e., during the slip operation of the clutch or brake, then an appropriate shift takes place to change from one shift element to the other shift element.

A further advantageous feature provides that slippage is divided in parallel between two shift elements.

In this, by the use of a sensor and in particular a coupling shaft sensor, the system can be controlled strategically in such a manner that the division of the slippage between the shift elements involved is continuously variable. Particularly advantageous for the structural design of the shift elements is a division of the slippage between a clutch and a brake. In the context of this variant, for example, only the brake coupling need be designed thermally as a starting coupling, with the advantage that the clutches parallel to the brake which transmit the torque do not have to be designed any more robustly than an ordinary shift clutch. The coupling sensor can also be integrated in a Mechatronic module without problems.

Thanks to the proposed division of the friction performance between two shift elements, the latter can each be made less robust, and this takes up considerably less structural space and reduces the weight of the gearbox.

Compared with the usual single-clutch concept as the starting shift element, the version described here also has extended strategic possibilities.

Below, the invention will be explained in greater detail with reference to the attached drawing, showing:

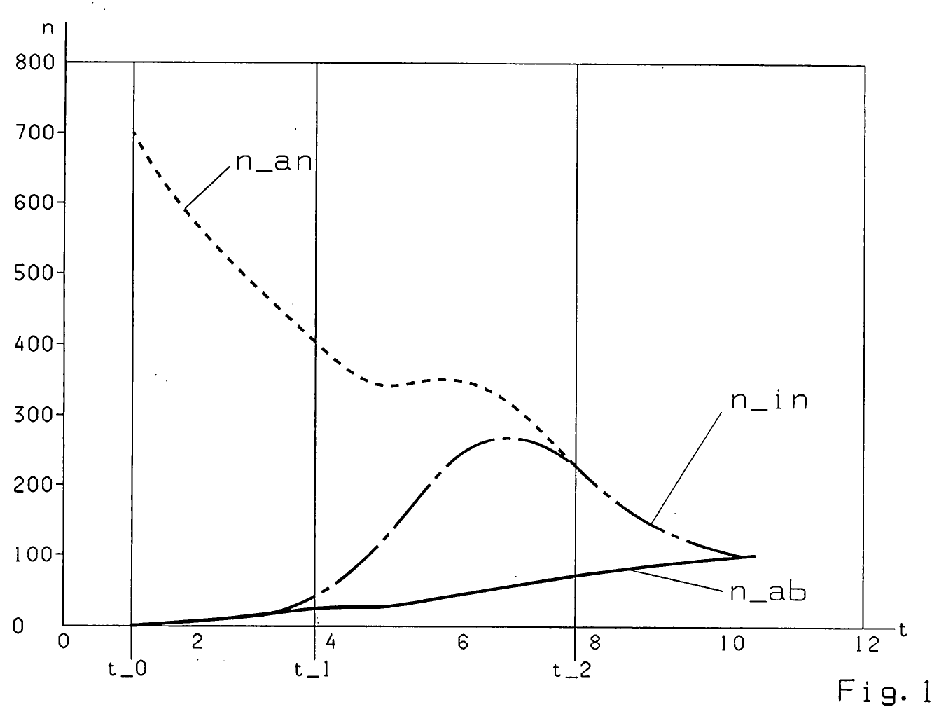

FIG. 1 is a speed-time diagram of a starting process according to the present invention;

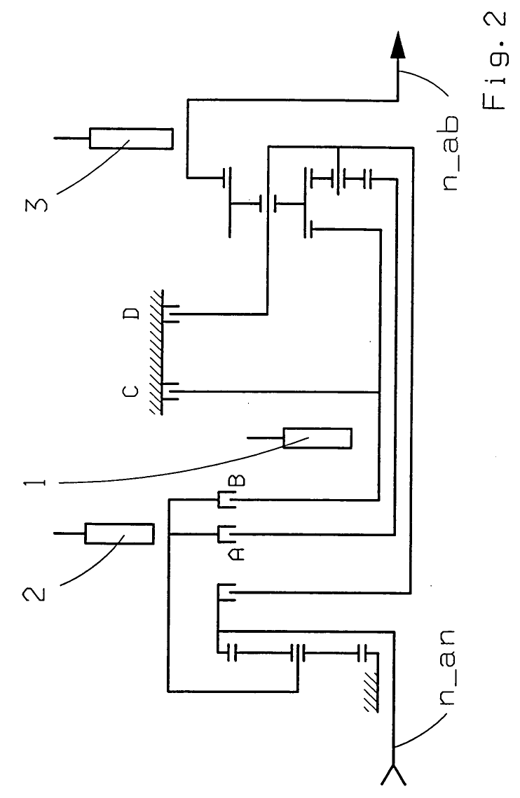

FIG. 2 is a schematic representation of the clutch and sensor arrangement, considering the example of an automatic gearbox;

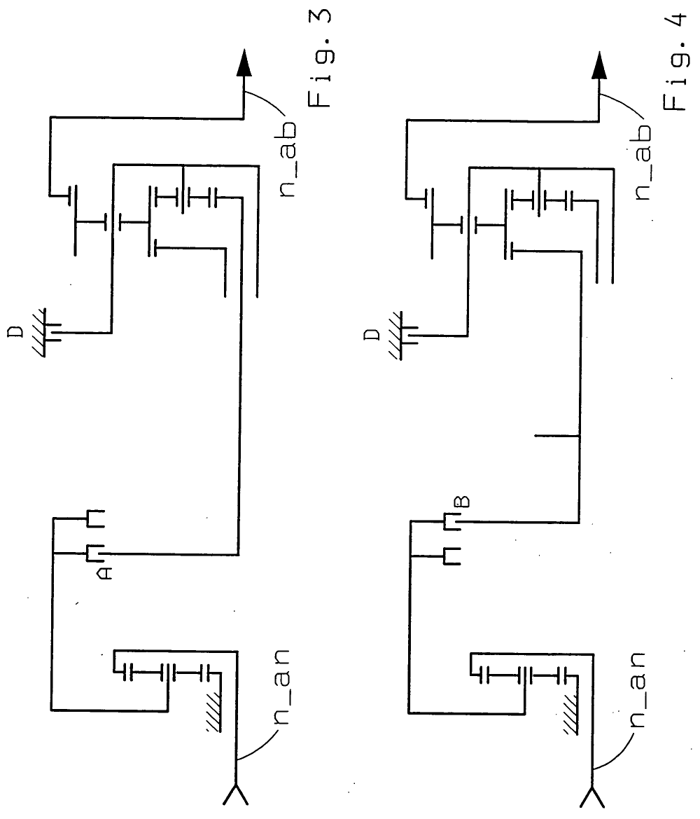

FIG. 3 is a force flow scheme of the automatic gearbox of FIG. 2, in the first forward gear; and

FIG. 4 is a force flow scheme of the automatic gearbox of FIG. 2, in reverse gear.

According to the first variant of the invention, it is now provided that when the “normal” starting clutch is thermally overloaded, the second clutch in the force flow is also brought into the slipping phase by reducing the clutch pressure. The first clutch is then closed, so that the second clutch takes over the starting process. A typical case for such a situation is, for example, starting under high load.

According to the invention, such a procedure is also provided when the “normal” starting clutch is designed for “sensitive” starting. The second clutch has its pressure adjusted to a certain value when the torque on the first clutch exceeds a certain value, the second clutch automatically begins slip operation. The first clutch is closed and the second clutch takes over the starting process.

In general, according to the invention when the clutches are designed for different torques, “normal” starting takes place by regulation and/or control of the clutch designed for the lower torque while at the same time the clutch designed for the higher torque is closed, but in contrast, starting under high load takes place by regulation and/or control of the higher-torque clutch.

In this connection, it has been found particularly advantageous to provide a speed sensor, which determines the speed between the two clutches at a suitable point.

FIG. 1 shows a speed-time diagram of a starting process, which takes no account of any possible gear shift during this starting process and without any accelerator pedal change by the driver during the starting process. At the beginning of the starting process (time t_0) the drive output speed n_ab, represented by the continuous curve, is zero, while the drive input speed n_an (broken curve) has a high value. At time t_1, according to the invention the second starting shift element also begins operating with slippage, while the first shift element is rapidly closed, so that at a later time t_2 the speed difference n_in between the two shift elements (dot-dash curve) is the same as the drive input speed n_an.

According to the invention, this replacement function can also be used when a corresponding diagnosis function recognises that one clutch is damaged, to prevent that clutch from being used any longer as the starting element and thus to treat it gently.

During normal starting the “normal” clutch takes over the starting process, while the second clutch remains closed.

Whereas in the variant of the method already explained the shift elements take over the slippage in alternation, in another variant the slippage can be divided between at least two clutches.

The schematic structure of an example automatic gearbox is illustrated in FIG. 2. FIG. 3 shows the force flow in the first forward gear, and FIG. 4 the force flow in the reverse gear, in each case with two shift elements in the force flow.

With parallel torque transmission during starting via both of the shift elements in the force flow, for example, when starting to drive forward in first gear the forward clutch A and the brake D can each take up half of the starting slippage, and when starting to drive in reverse, the reversing clutch B and the brake D likewise.

The system can be operated in accordance with the stated strategy thanks to the use of a sensor, in particular a coupling shaft sensor 1 in combination with the already present sensors 2, 3 for the drive input speed n_an and the drive output speed n_ab, respectively.

This means that in the present case the division of the slippage between clutch and brake can be continuously controlled, so that the coupling sensor can be integrated into the Mechatronic module without problems.

This variant has the advantage that only the brake D is thermally designed as a starting coupling, while the forward and reversing clutches A and B do not need to be designed with a thermally more robust structure than normal shift clutches.

It is also possible that only slight slippage occurs at the clutch and that most of the slippage occurs in the brake, and vice-versa. Then, with the brake closed the starting process begins on the clutch for a short time; subsequently, the brake or another clutch takes over the rest of the starting process and hence also the greater part of the frictional energy.

### Reference Numerals

1 Coupling shaft sensor

2 Sensor for the drive input speed

3 Sensor for the drive output speed

n_an Drive input speed

n_ab Drive output speed

n_in Speed between the two couplings

A Forward clutch

B Reversing clutch

C, D Brakes

1. Method for reducing the thermal stress of starting shift elements in automatic gearboxes or automated manual gearboxes with at least two shift elements in the force flow, characterized in that when starting, besides a first shift element at least a second shift element present in the force flow is used, which takes up at least part of the slippage.

2. Method according to claim 1, characterized in that the slippage is divided sequentially in time.

3. Method according to claims 1 or 2, characterized in that the slippage is divided in parallel with regard to time.

4. Method according to any of the preceding claims, characterized in that the division of the slippage can be controlled continuously.

5. Method according to claim 4, characterized in that a coupling shaft sensor (1) is provided for the division of the slippage.

6. Method according to claim 5, characterized in that the coupling shaft sensor (1) can be integrated in a Mechatronic module.

7. Method according to any of the preceding claims, characterized in that a shift to another gear takes place when a shift element has reached its thermal stress limit, in order to use the shift elements in the force flow of the said other gear as slipping starting elements.

8. Method according to any of the preceding claims, characterized in that a monitoring function is provided, which checks the thermal stressing of the shift elements.

9. Method according to claim 8, characterized in that the monitoring function comprises a heat model of the shift elements and/or processes signals from at least one monitoring sensor, in particular a temperature sensor, on the shift elements.

10. Method according to any of the preceding claims, characterized in that if the “normal” shift element becomes thermally overloaded, the second shift element present in the force flow, by reducing its pressure, is also brought to the slipping phase, and the first shift element is then rapidly closed so that the second shift element takes over the starting process.

11. Method according to any of the preceding claims, characterized in that if the shift elements are designed for different torques, “normal” starting takes place by the control and/or regulation of the lower-torque shift element while at the same time the higher-torque shift element is closed, and in contrast starting under high load takes place by the control and/or regulation of the higher-torque shift element.

12. Method according to any of the preceding claims, characterized in that when damage is recognised in a shift element, that shift element is no longer used as a starting element.
